(19) United States
(12) Patent Application Publication
(10) Pub. No.: US 2005/0209970 A1
(43) Pub. Date: Sep. 22, 2005

(54) Conditional-access terminal device and method

(76) Inventors: Masue Shiba, Fuchu-shi (JP); Koji Yura, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/079,204

(22) Filed: Mar. 15, 2005

(30) Foreign Application Priority Data
Mar. 22, 2004 (JP) 2004-083241

(51) Int. Cl. H04K 1/00

(52) U.S. Cl. 705/52

(57) ABSTRACT

According to a first aspect of the present invention, a conditional-access program can be updated without replacing a conditional-access large scale integrated circuit (LSI) or a conditional-access terminal device main-body. A conditional-access terminal device reads and decrypts an encrypted conditional-access program from a memory storage device at start-up, and executes conditional-access processing in conformity to the obtained conditional-access program. Consequently, by replacing the memory storage device, the conditional-access program can be updated.

### CROSS-REFERENCE TO RELATED APPLICATIONS

This application is based upon and claims the benefit of priority from prior Japanese Patent Application No. 2004-083241, filed Mar. 22, 2004, the entire contents of which are incorporated herein by reference.

### BACKGROUND OF THE INVENTION

1. Field of the Invention

The present invention relates to a conditional-access terminal device for use in paid digital broadcasting, and specifically to a conditional-access terminal device that can update conditional-access programs and information concerning the contract without replacing a conditional-access LSI or conditional-access terminal device main-body and the method thereof.

2. Description of the Related Art

As conventional paid broadcasting receiving sets, a broadcasting-conditional access system (B-CAS) card of broadcasting satellite (BS) digital broadcasting, a conditional-access terminal device (receiving terminal) of mobile satellite digital broadcasting, and others are known. In this case, explanation will be made with a conditional-access terminal device of mobile satellite digital broadcasting taken as an example.

FIG. 1 is a block diagram that shows a configuration of this kind of conditional-access terminal device of mobile satellite digital broadcasting. The conditional-access terminal device comprises a memory 1, a CPU 2, an antenna 3, a tuner 4, a code-division multiplex/forward error correction (CDM/FEC) unit 5, a conditional-access large scale integrated circuit (CALSI) 6, a decoder 7, a display control unit 8, an audio signal output unit 9, and a bus 10. The elements 1, 2, and 4 to 7 except the antenna 3, the display control unit 8, and the audio signal output unit 9 are connected one another via the bus 10.

Now, to start conditional-access, when the CALSI 6 receives a command from the CPU 2, the CALSI 6 obtains a code-compressed transport stream packet TS from broadcasting waves via the antenna 3, the tuner 4, and the CDM/FEC unit 5. In such event, the CALSI 6 refers to an EEPROM 6a having stored therein information concerning the contract of its own terminal, while the CALSI 6 obtains information concerning the contract from the transport stream packet TS.

As a result of this reference, the CALSI 6 prepares a scramble key of the broadcasting content from the transport stream packet TS if the information concerning the contract of its own terminal that agrees with the transport stream packet TS is stored in the EEPROM 6a.

Thereafter, the CALSI 6 descrambles the broadcasting content prescrambled in the transport stream packet TS in conformity to this scramble key, and outputs the obtained transport stream packet TS to the decoder 7.

The decoder 7 decodes the entered transport stream packet TS, separates the obtained image data and voice data from each other and processes to decrypt, and outputs the obtained audio signals and video signals to the display control unit 8 and the audio signal output unit 9. Note that the data under processing is stored accordingly in a DRAM 7a.

In the conditional-access terminal device as described above, a conditional-access module and descrambler of broadcasting content are assembled in a substrate as one chip of the CALSI 6.

The CALSI 6 has a host interface that communicates with the CPU 2 of the conditional-access terminal device. The CALSI 6 is formed by the hardware logic such as an I/O interface of the transport stream packet TS via an internal bus, a buffer, an internal CPU for conditional access, an accelerator for encryption and decryption, and the like.

The CALSI 6 is an LSI which serves as a key to paid broadcasting. The CALSI 6 possesses individual information of broadcasting business and private information of the audience, encryption and decryption algorithms, key, and the like, thus requiring tamper-resistant implementation. Consequently, in the CALSI 6, a conditional-access program for the internal CPU and a terminal specific ID are sealed in a mask ROM which is unable to be electrically accessed from the outside at the time of LSI manufacture. In addition, when the information concerning the contract is obtained from broadcasting waves, it is written and stored in the nonvolatile memory (EEPROM) 6a in the CALSI 6 while being associated with the terminal specific ID.

However, this kind of conditional-access terminal device is difficult to update the conditional-access program inside the mask ROM when the CALSI 6 is assembled in a substrate. Consequently, when the conditional-access program is updated, the CALSI 6 must be replaced or the conditional-access terminal device must be replaced.

Similarly, when the nonvolatile memory 6a which stores the information concerning the contract fails and the lot information concerning the contract is restored, the CALSI 6 must be replaced or the conditional-access terminal device must be replaced as well.

In the prior-art document information of the present invention, there are, for example, Jpn. Pat. Appln. KOKAI Publication No. 2000-151526 (hereinafter referred to as the first KOKAI publication) and Jpn. Pat. Appln. KOKAI Publication No. 2003-134492 (hereinafter referred to as the second KOKAI publication).

Now, in the first KOKAI publication, a technique that uses an IC card which forms a security module and independently descrambles in each apparatus which accessed the IC card is described (see paragraphs 16 and 17).

In the second KOKAI publication, a technique that uses a contract information moving means which holds the contract information and moves the contract information by transferring the contract information between the contract information moving means and the receiving unit (see paragraph 9).

However, the first and the second KOKAI publications have no description concerning updating of a conditional-access program. In addition, similarly, the first and the second KOKAI publications have no description on restoring the lost contract information when nonvolatile memory fails. In particular, the technique stipulated in the second KOKAI publication stores the contract information in the contract information moving means when the contract information is moved, but after the contract information is moved, the receiving unit is responsible for storing the contract information. Therefore, when the nonvolatile memory of the receiving unit fails after the contract information is moved, the contract information in the nonvolatile memory is lost.

### BRIEF SUMMARY OF THE INVENTION

It is an object of the present invention to provide a conditional-access terminal device and method that can update a conditional-access program without replacing a CALSI or a conditional-access terminal device main-body.

It is another object of the present invention to provide a conditional-access terminal device and method that can restore contract-related information without replacing a CALSI or a conditional-access terminal device main-body.

According to a first aspect of the present invention, there is provided a conditional-access terminal device for executing conditional-access processing for a secure memory storage device in which an encrypted conditional-access program and an encryption program key for decrypting the conditional-access program by a conditional-access program obtained from the secure memory storage device, the device comprising: a conditional-access large scale integrated circuit (LSI) having a memory from and to which the conditional-access program is read and written and a processor which executes conditional-access processing in conformity to the conditional-access program in the memory; a device configured to read the encrypted conditional-access program and the encryption program key from the secure memory storage device at start up; a device configured to decrypt the encrypted conditional-access program in conformity to the encryption program key and to obtain the conditional-access program; and a device configured to write the obtained conditional-access program in memory of the conditional-access LSI.

According to the first aspect, by the configuration to read the encrypted conditional-access program from the secure memory storage device and decrypt at start-up, and execute conditional-access processing in conformity to the obtained conditional-access program, the secure memory storage device may replaced when the conditional-access program is updated. Therefore, the conditional-access program can be updated without replacing the CALSI or conditional-access terminal device main-body.

According to a second aspect of the present invention, there is provided a conditional-access terminal device for executing conditional-access processing for a secure memory storage device in which encrypted “contract-related information” and an encryption contract information key for decrypting the “contract-related information” by “contract-related information” obtained from the secure memory storage device, the terminal device further comprising: a conditional-access large scale integrated circuit (LSI) having a memory from and to which the “contract-related information” is read and written and a processor which executes conditional-access processing in conformity to the “contract-related information” in the memory; a device configured to read the encrypted “contract-related information” and the encryption contract information key from the secure memory storage device at start-up; a device configured to decrypt the encrypted “contract-related information” in conformity to the encryption contract information key and to obtain the “contract-related information”; a device configured to write the obtained “contract-related information” in memory of the conditional-access LSI; a device configured to send the new “contract-related information” from the relevant conditional-access LSI when the new “contract-related information” is received while conditional-access processing by the conditional-access LSI is being carried out; and a device configured to encrypt the sent-out “contract-related information” by the encryption contract information key and transfer the obtained encrypted “contract-related information” to the secure memory storage device to update and store.

According to the second aspect, by the configuration to read the encrypted “contract-related information” from the secure memory storage device and decrypt at start-up, and execute conditional-access processing in conformity to the obtained “contract-related information,” the secure memory storage device may replaced when the secure memory storage device fails and the contract-related information is lost. Therefore, the contract-related information can be restored without replacing the CALSI or conditional-access terminal device main-body.

Each aspect of the present invention is expressed by the name of “unit” but it is needless to say that the present invention shall not be restricted to this but each aspect of the present invention may be expressed by the use of other names such as “system,” “method,” “storage medium that can be read by computer,” or “program.”

### BRIEF DESCRIPTION OF THE SEVERAL VIEWS OF THE DRAWING

FIG. 1 is a block diagram that shows a configuration of a conventional conditional-access terminal device;

FIG. 2 is a block diagram that shows a configuration of a conditional-access terminal device according to a first embodiment of the present invention;

FIG. 3 is a block diagram that shows a configuration of a memory storage device in the embodiment;

FIG. 4 is a block diagram that shows a configuration of a CALSI in the embodiment;

FIGS. 5 and 6 are sequence diagrams to explain a conditional-access method in the embodiment;

FIG. 7 is a block diagram that shows a configuration of a memory storage device for use in a conditional-access terminal device according to a second embodiment according to the present invention;

FIG. 8 is a block diagram that shows a configuration of a memory storage device for use in a conditional-access terminal device according to a third embodiment according to the present invention;

FIG. 9 is a block diagram that shows a configuration of a memory storage device for use in a conditional-access terminal device according to a fourth embodiment according to the present invention;

FIG. 10 is a sequence diagram to explain a conditional-access method in the embodiment;

FIG. 11 is a block diagram that shows a configuration of a memory storage device for use in a conditional-access terminal device according to a fifth embodiment according to the present invention;

FIG. 12 is a block diagram that shows a modified configuration of the embodiment; and

FIG. 13 is a block diagram that shows a configuration of a conditional-access terminal device according to a sixth embodiment according to the present invention.

### DETAILED DESCRIPTION OF THE INVENTION

Embodiments of the present invention will be described in detail hereinafter with reference to the accompanying drawings.

### First Embodiment

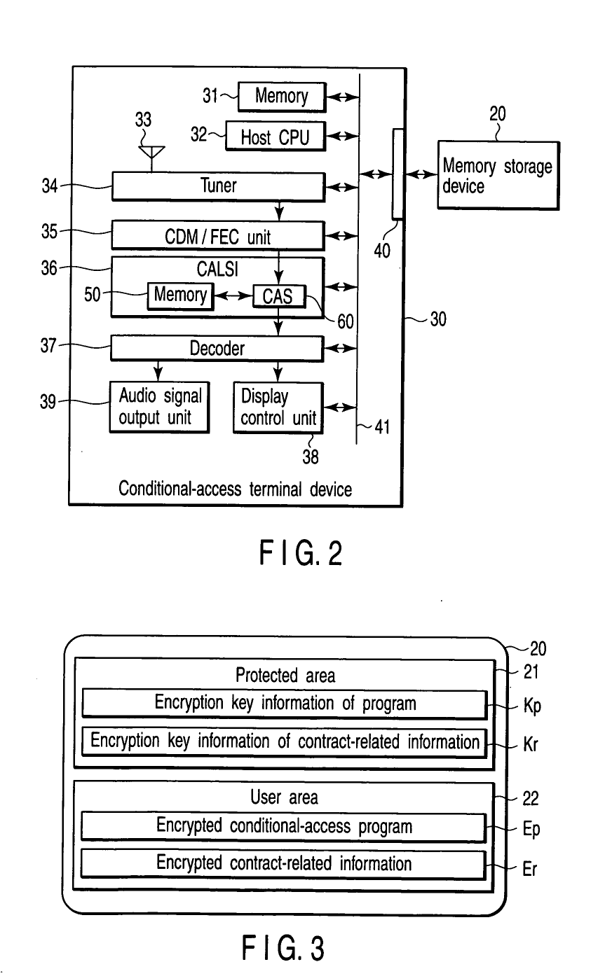

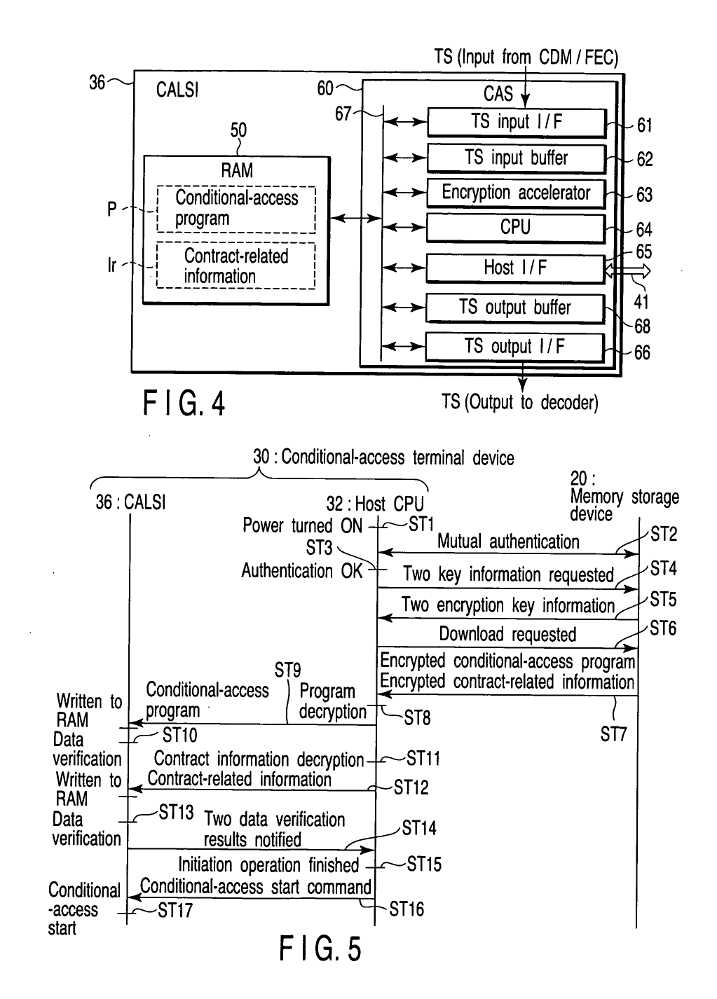

FIG. 2 is a block diagram that shows a configuration of a conditional-access terminal device according to a first embodiment of the present invention, and FIG. 3 is a block diagram that shows a configuration of a memory storage device in the embodiment. Now, a memory storage device (secure memory storage device) 20 has at least an device authentication function for authenticate a conditional-access terminal device 30. In this event, the memory storage device 20 has the device authentication function (hereinafter called the “mutual authentication function”) between the memory storage device 20 and conditional-access terminal device 30, and is equipped with a protected area 21 and a user area 22. Such an device authentication function is used under the conditions in which the memory storage device 20 and conditional-access terminal device 30 have a key K of a private key cipher in advance, and for example, there are a system for the memory storage device 20 to verify the validity of the conditional-access terminal device 30 and a system for the device 20, 30 to verify the validity of the counterpart device 30, 20. The former system is described as a “private key cipher base counterpart authentication system 1” and “private key cipher base counterpart authentication system 2” in “Section 9.2 System based on the private key cipher” in page 153 to page 154 of literature (Series/Mathematics of Information Science: Modern Ciphers” written by T. Okamoto and H. Yamamoto, First edition, Sangyo Tosho Publishing Co., Jun. 30, 1997, pp. 153-155). The latter system is described as a “private key cipher base mutual authentication system” in, for example, page 154 to page 155 of the same literature.

The protected area 21 is a storage area which becomes accessible from the conditional-access terminal device by mutual authentication (device authentication) with the conditional-access terminal device 30. In the protected area 21, encryption key information (encryption program key) Kp for decrypting an encrypted conditional-access program in the user area 22 and encryption key information (encryption contract information key) for decrypting “contract-related information” encrypted in the area 22 are stored. The encryption key information Kp, Kr can apply either of an encryption key itself or seed information for generating an encryption key. When the seed information is used, an encryption key should be generated by carrying out computations of one-way function by the specified times to the seed information. The specified times may be the times which are determined by the version or the years of contract, etc.

The user area 22 stores a conditional-access program Ep encrypted in accordance with the encryption key information Kp and “contract-related information” Er encrypted in accordance with the encryption key information Kp in accordance with the algorithm. The contract-related information contains a work key to obtain a scramble key necessary for encrypt the broadcasting content and contract information to use the work key. The contract information shows services on which a contract is made with the terminal ID of the conditional-access terminal device 30. The services on which a contract is made indicate channels permitted to decrypt or programs or expiration date, etc.

For the memory storage device 20, for example, SD cards or cards derived from SD cards can be suitably used, but the memory storage device are not be restricted to these. For example, the memory storage device 20 may only have a function to mutually authenticate a host CPU 32 and a function to protect data communicated with the host CPU 32. The effect that the memory storage device 20 is not restricted by SD cards, etc. is same as in each of the following embodiments.

On the other hand, the conditional-access terminal device 30 comprises a memory 31, the host CPU 32, an antenna 33, a tuner 34, a CDM/FEC unit 35, a conditional-access LSI (CALSI) 36, a decoder 37, a display control unit 38, an audio signal output unit 39, a slot 40, and a host bus 41, as shown in FIG. 2. All the elements 31, 32, 34 to 38, and 40 excluding the antenna 33 and the audio signal output unit 39 are connected each other via the host bus 41. The data on the host bus 41 may be encrypted by encryption algorithm other than the encryption algorithm of a content protection mechanism or encryption algorithm related to conditional reception.

Now, the memory 31 is a device to and from which the data read from the memory storage device 20 by the host CPU 32, data to be transferred to the memory storage device 20, and the like are read and written.

The host CPU 32 has an interface function with the memory storage device 20, and for example, executes a mutual authentication function (device authentication function) with the memory storage device 20 as well as encryption and decryption functions of communicated data with the memory storage device 20.

The antenna 33 receives broadcasting waves including scrambled program content and sends the obtained received signals to a tuner.

The tuner 34 tunes in the received signals sent from the antenna 33 to the designated channel and sends the received signals after tuning in to the CDM/FEC unit 35.

The CDM/FEC unit 35 generates a transport stream packet TS and sends out to the CALSI 36 by demodulation-processing the received signals received from the tuner 34 based on the code division multiple (CDM) system and by error-correction-processing them by forward error correction (FEC).

Now, the transport stream packet TS contains encrypted broadcasting content and the related information for watching and listening to this broadcasting content. The related information includes an encryption scramble key which is formed by the scramble key encrypted by the work key, which is required for encrypting the broadcasting content and contract-information to decrypt and use this encryption scramble key. The contract information is a gigantic list that indicates services on which the contract is executed with a contractor (terminal ID) of digital broadcasting. The contracted services indicate channels which are allowed to decrypt, or indicate programs and validity period.

The CALSI 36 is equipped with a RAM 50 and a conditional-access system (CAS) 60.

The RAM 50 is a readable/writable memory from the CAS 60 and stores contract-related information Ir received from broadcasting waves and communication network as well as a conditional-access program P read from the memory storage device 20 are stored. The RAM 50 is one example of memories in the CALSI 36. As the memory in the CALSI 36, either of a volatile memory or a nonvolatile memory may be used. However, from the viewpoint of improving the security, a RAM and other volatile memories are desirable.

The CAS 60 comprises a TS input I/F 61, a TS input buffer 62, an encryption accelerator 63, a CPU 64, a host I/F 65, a TS output I/F 66 and a TS output buffer 68, and other hardware logics. All the elements 61 to 66, 68, and the RAM 50 are connected to each other through the bus 67 in the CAS 60.

TS input I/F 61 is an input interface between the CDM/FEC unit 35 and the CAS 60, and has a function to input the transport stream packet TS sent from the CDM/FEC unit 35 to the buffer 62.

The TS input buffer 62 is a readable/writable memory from each of the elements 61 to 66 via the bus 67, and the transport stream packet TS under conditional-access processing is temporarily stored.

The encryption accelerator 63 is controlled by the CPU 64 and has a function to descramble the scrambled broadcasting content in the transport stream packet TS in the buffer 62 by a scramble key and a function to output the transport stream packet TS comprising the broadcasting content after descrambling to the TS output buffer 68.

The TS output buffer 68 is a readable/writable memory from each of the elements 61 to 66 via the bus 67, and the transport stream packet TS comprising broadcasting content after descrambling is temporarily stored.

The CPU (processor) 64 executes conditional-access processing of the transport stream packet TS in the buffer 62 on the basis of the conditional-access program in the RAM 50. In this event, conditional-access processing comprises the following processing steps (CA1) to (CA4).

(CA1) Processing to separate scrambled broadcasting content and related information from the transport stream packet TS. (CA2) Processing to collate the contract information (list of contractor terminal IDs) inside the related information with the contract-related information (terminal ID) inside the RAM 50. (CA3) Processing to decrypt the encryption scramble key in the related information by the work key in the contract-related information and obtain a scramble key when both conform as a result of collation. (CA4) Processing to input the obtained scramble key and scrambled broadcasting content to the encryption accelerator 63.

The host I/F 65 has an interface function between the host CPU 32 and the RAM 50 and for example, has a function to write the conditional-access program P inputted from the host CPU 32 or contract-related information Ir to the RAM 50 at start-up.

The TS output I/F 66 outputs the transport stream packet TS outputted from the TS output buffer 68 to the decoder 37.

The decoder 37 has a function to restore video signals and audio signals from the transport stream packet TS outputted from the CAS 60 of the CALSI 36 and output the obtained video signals to the display control unit 38, and a function to output the obtained audio signal to the audio output unit 39.

The display control unit 38 display-controls a display device (not shown) in conformity to video signals outputted from the decoder 37. However, this shall not be restricted to this but may have a function to display messages inputted from the host bus 41 as required. Examples of the messages include “Mutual authentication failed. Check memory storage device 20,” and others.

The audio output unit 39 outputs voices in conformity to audio signals outputted from the decoder 37.

The slot 41 removably holds the memory storage device 20.

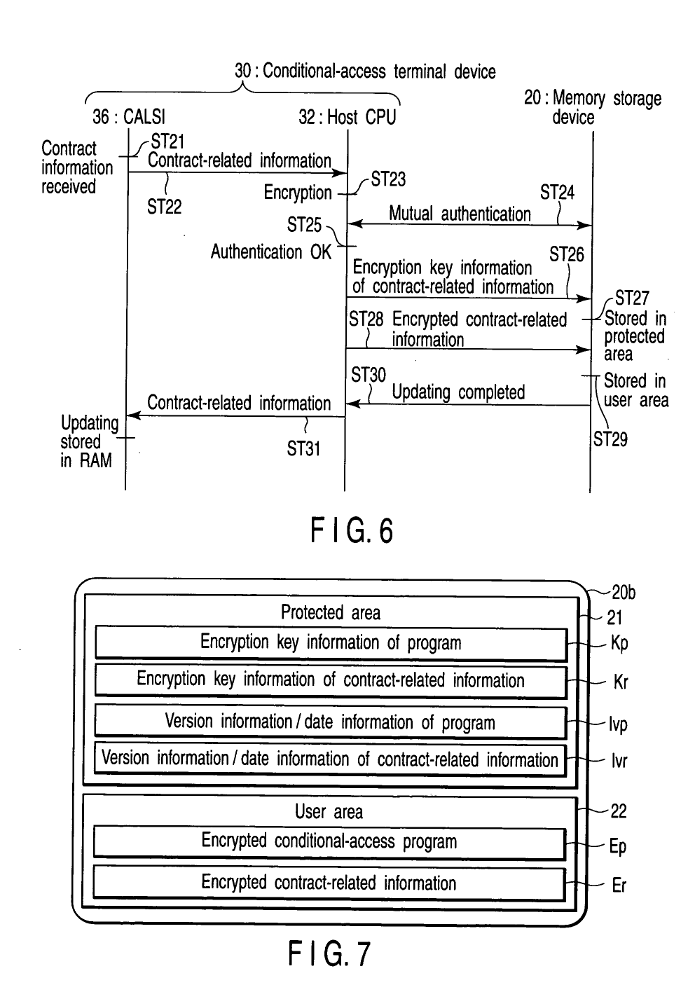

Referring now to sequence diagrams of FIGS. 5 and 6, a conditional-access method by the memory storage device and a conditional-access terminal device configured as above are described.

(Initialization Operation)

The conditional-access terminal device 30 is started by an operator who turns on power supply (ST1). At the time of start-up, the conditional-access terminal device 30 initializes the whole unit.

The host CPU 32 of the conditional-access terminal device 30 executes mutual authentication with the memory storage device 20 (ST2). In the event that the mutual authentication result is NG (authentication fails), the unit makes an error stop without carrying out processing of step 4 and after.

On the other hand, in the event that the mutual authentication result of step ST2 is OK (authentication is succeeded) (ST3), the host CPU 32 requests two encryption key information Kp, Kr to the memory storage device 20 (ST4), reads the encryption program key Kp and encryption contract information key Kr from the protected area 21 of the memory storage device 20 (ST5), and writes them in the memory 31.

Then, the host CPU 32 requests the memory storage device 20 to download two pieces of encryption information Ep, Er, reads the encrypted conditional-access program Ep and encrypted contract-related information Er from the user area 22 of the memory storage device 20 (ST7), and writes them in the memory 31.

The host CPU 32 decrypts the encrypted conditional-access program Ep in conformity to the encryption key information Kp in the memory 31 (ST8) and writes the obtained conditional-access program P in the RAM 50 of the CALSI 36.

The CALSI 36 carries out known data verification such as any sign of bit error, etc. to the conditional-access program P in the RAM 50.

On the other hand, the host CPU 32 decrypts the encrypted contract-related information Er in conformity to the encryption key information Kr in the memory 31 (ST11) and writes the obtained contract-related information Ir in the RAM 50 of the CALSI 36 (ST12).

The CALSI 36 carries out the above-mentioned similar data verification such as any sign of bit error, etc. to the contract-related information in the RAM 50.

Then, the CALSI 36 notifies the verification results of these two data to the host CPU 32 (ST14).

The host CPU 32 makes an error stop in the event either of the two data verification results is abnormal. In addition, when both of the two data verification results are normal, the host CPU 32 completes initialization action (ST15) and inputs a conditional-access start command to the CALSI 36 (ST16). This causes the CALSI 36 to start conditional-access processing (ST17).

The tuner 34 and CDM/FEC unit 35 receive broadcasting waves in conformity to the specified routine and input the obtained transport stream packet TS to the CALSI 36.

The CALSI 36 executes conditional-access processing of this transport stream packet TS, descrambles the scrambled broadcasting content, and outputs it to the decoder 37. The decoder 37 restores video signals and audio signals from the descrambled broadcasting content and outputs video signals and audio signals.

This concludes initialization action of the conditional-access terminal device 30.

Thereafter, in the event that any need to update the conditional-access program P occurs, such as change of functions or detection of bugs, in the conditional-access program P during broadcasting operation, the audience can change functions and dissolve bugs by replacing the memory storage device 20 in conformity to the message from the conditional-access terminal device 30 or broadcasting center.

In addition, even when the memory storage device 20 fails and the conditional-access program P of the contract-related information Ir is lost, it is possible to restore the conditional-access program P or contract-related information Ir by replacing the memory storage device 20.

(Updating Operation for Contract-Related Information)

Assume that the CALSI 36 obtains contract-related information Ir of its own terminal during receiving operation as shown in FIG. 6 (ST36).

In such event, the CALSI 36 sends out contract-related information Ir to the host CPU 32 (ST22). When the host CPU 32 receives this contract-related information Ir, the encryption key information is prepared in response to the content protection mechanism and encrypts contract-related information Ir in accordance with the encryption key information obtained (ST23).

Then, the host CPU 32 carries out mutual authentication with the memory storage device 20 (ST24). If mutual authentication is OK (ST25), the host CPU 32 transfers the encryption key information Kr of contract-related information to the memory storage device 20 (ST26). The memory storage device 20 stores this encryption key information Kr in the protected area 21 (ST27). In the event that the mutual authentication of step ST25 is NG, the host CPU makes an error stop.

Thereafter, the host CPU 32 transfers the encrypted contract-related information Er obtained in step ST23 to the memory storage device 20 (ST28). The memory storage device 20 stores the encrypted contract-related information Ir in the user area 22 (ST29) and notifies the host CPU 32 of the completion of updating (ST30).

The host CPU 32 writes the contract-related information Ir to the RAM 50 of the CALSI 36 when the completion of updating is notified. This concludes updating of contract-related information.

According to the embodiment as described above, it is configured in such a manner that when the conditional-access terminal device 30 is started, the encrypted conditional-access program Ep is read from the memory storage device 20 and decrypted, and conditional-access processing is executed in conformity to the obtained conditional-access program P. Accordingly, when the conditional-access program is updated, the memory storage device 20 only should be replaced. In this way, it is possible to update the conditional-access program without replacing the CALSI 36 or conditional-access terminal device 30 main-body.

In the same manner, the conditional-access terminal device 30 is configured to read the encrypted contract-related information Er from the memory storage device 20 at start-up and decrypt, and execute conditional-access processing in conformity to the obtained contract-related information Ir. Accordingly, when the memory storage device 20 fails and the contract-related information Ir is lost, the memory storage device 20 should only be replaced. In this way, contract-related information can be restored without replacing the CALSI 36 or conditional-access terminal device 30 main-body. In addition, by the configuration in which the encrypted contract-related information Er is stored in the memory storage device 20, unlike to conventional one, there is no need to incorporate the EEPROM in the CALSI.

The above-mentioned replacement of the memory storage device 20 may be carried out by the use of any of the following methods. The first method is a system to allow the broadcasting center to issue a new memory storage device which stores the encrypted conditional-access program Ep, contract-related information Er, their encryption key information Kp, Kr, and the like. The second method is a system to update programs related to conditional-access by broadcasting waves. The second method can be achieved by combining encryption processing that corresponds to the content protection mechanism of the memory storage device 20 with the software updating function of the conditional-access terminal device 30 which uses broadcasting wave engineering slot.

### Second Embodiment

FIG. 7 is a block diagram that indicates a configuration of a memory storage device for use in a conditional-access terminal device according to a second embodiment of the invention. The parts same as those in FIG. 3 are designated by the same reference characters and their detailed description is omitted, and in this part of the section, different parts are primarily discussed. In each of the following embodiments, redundant description will be omitted in the same manner.

That is, the present embodiment is a modification example of the first embodiment and is configured to impart a function to control versions of the conditional-access program and contract-related information from the viewpoint of improving resistance to attacks using past information.

Specifically, the conditional-access program has content including version control information (Ivp) such as versions or dates. Similarly, the contract-related information contains versions or version control information (Ivr) including dates.

As a result, in addition to the encryption key information Kp, Kr, version control information Ivp of the conditional-access program and version control information Ivr of the contract-related information are stored in the protected area 21.

On the other hand, the following functions (f30-1) and (f30-2) are added to the host CPU 32 of the conditional-access terminal device 30. (f30-1) It is function to read version control information Ivp, for example, at start-up, from a memory storage device 20b, collate this version control information Ivp with the version control information (Ivp) contained in the encrypted conditional-access program P, and block execution of conditional-access processing in the event that both do not coincide as a result of collation.

(f30-2) It is function to read version control information Ivr, for example, at start-up, from a memory storage device 20b, collate this version control information Ivr with the version control information (Ivr) contained in the encrypted contract-related information Ir, and block execution of conditional-access processing in the event that both do not coincide as a result of collation.

According to the foregoing configuration, even if an attack to overwrite the new data with obsolete data is encountered, execution of conditional-access processing is blocked because the version control information of the overwritten obsolete data differs from the version control information in the protected area 22.

In addition, for example, even if an attack to delete the latest data and to use obsolete data is encountered, execution of conditional-access processing is blocked because the version control information of the obsolete data differs from the version control information in the protected area 22.

Moreover, even if either attack is blocked, the version control information Ivp, Ivr remain in the protected area 22, the latest data can be restored in conformity to the version control information Ivp, Ivr. Consequently, the resistance to attacks using past information can be improved.

### Third Embodiment

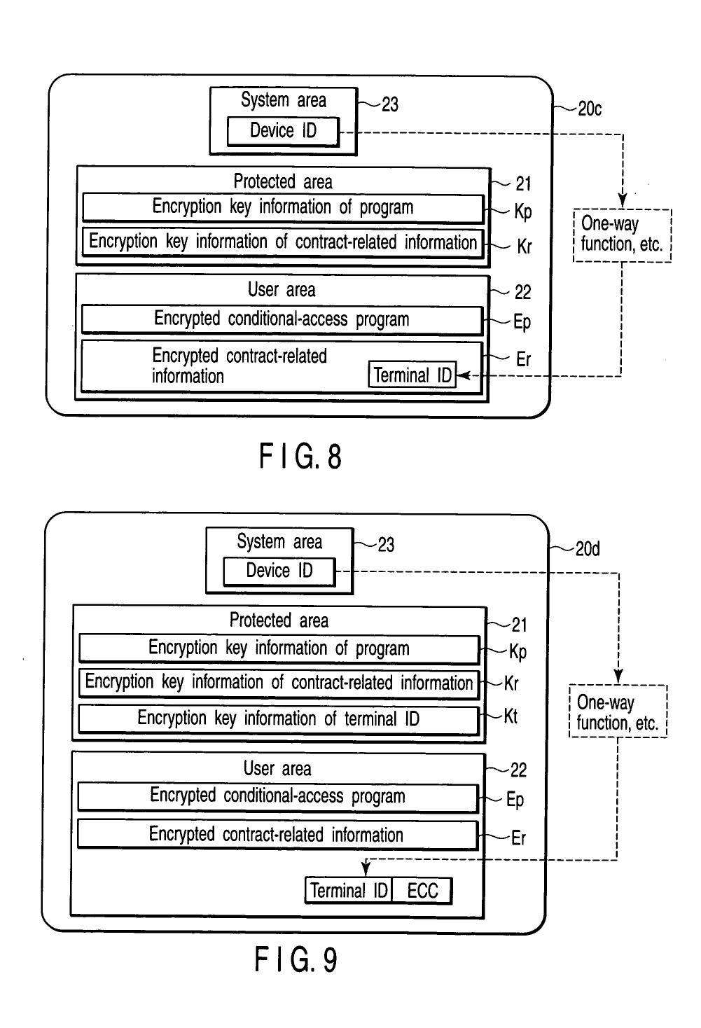

FIG. 8 is a block diagram that indicates a configuration of a memory storage device for use in a conditional-access terminal device according to a third embodiment of the invention.

The present embodiment is a modification example of the first embodiment. From the viewpoint of enabling watching and listening by a plurality of conditional-access terminal devices, it is configured to generate a terminal ID specific to the conditional-access terminal device to obtain contract-related information from a device ID specific to a memory storage device 20c and include it in contract-related to information.

Specifically, the memory storage device 20c is configured to store its own medium ID (medium identification information) in a system area 23. Now, the system area 23 is a read-only storage area in which the medium ID is written at the time of manufacturing the device.

The contract-related information contains a terminal ID computed from the medium ID. Examples of this computation include a system to perform arithmetic of one-way function on the medium ID, and the like.

As a result, the CALSI 36 has a function to execute conditional-access processing in conformity to the terminal ID contained in contract-related information Ir in the RAM 50.

According to the configuration as described above, because the terminal ID to acquire the contract-related information is generated from the device ID of the memory storage device 20c, the identification number of the conditional-access terminal device 30 main-body can be eliminated and TV viewers can enjoy by a plurality of conditional-access terminal devices by replacing the memory storage device 20c.

### Fourth Embodiment

FIG. 9 is a block diagram that shows a configuration of a memory storage device for use in a conditional-access terminal device according to a fourth embodiment of the invention.

The present embodiment is a modification example of the third embodiment and has a configuration in which a terminal ID generated from a device ID of a memory storage device 20d is stored in the memory storage device 20d.

Specifically, the memory storage device 20d comprises a system area 23, a user area 22, and a protected area 21. The self device ID is stored in the system area 23. The terminal ID computed from the device ID in the system area 23 and its error correction code (hereinafter called ECC) are encrypted and stored in the user area 22. In the protected area 21, the encryption key information (encryption identification information key) Kt of the terminal ID to decrypt the encrypted “terminal ID and ECC” in the user area 22 is stored.

As a result, the host CPU 32 of the conditional-access terminal device 30 reads the encryption key information Kt and encrypted medium ID and ECC from the memory storage device 20d at start-up and has a function to decrypt the encrypted medium ID and ECC in conformity to the encryption key information Kt, a function to obtain terminal ID and ECC, a function to carry out data verification of the terminal ID by ECC, and a function to write the terminal ID after data verification in the RAM 50 of the CALSI 36.

The CALSI 36 has a function to execute conditional-access processing in conformity to the terminal ID in the RAM 50.

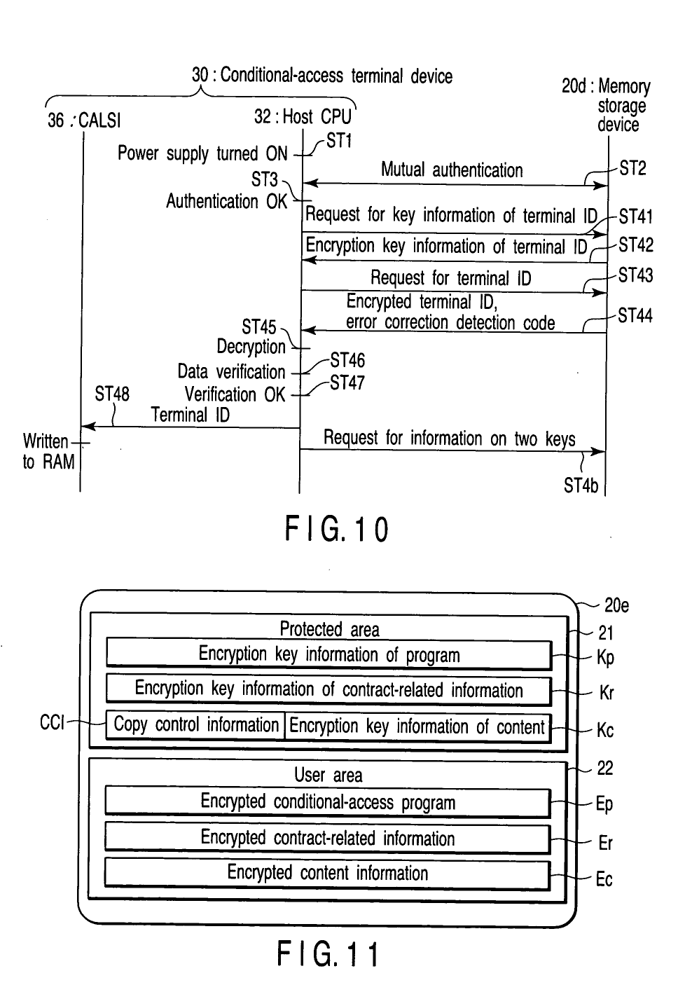

Referring now to the sequence diagram of FIG. 10, the memory storage device configured as described above and the conditional-access method by the conditional-access terminal device will be described.

The conditional-access terminal device 30 carries out operations from turning ON the power supply to OK'ing mutual authentication same as steps ST1 to ST3 as described above.

Then, the host CPU 32 requests the memory storage device 20 to furnish the encryption key information Kt of the terminal ID (ST41), reads the encryption key information Kt from the protected area 21 of the memory storage device 20 (ST42), and writes in the memory 31.

In addition, the host CPU 32 requests the memory storage device 20 to download the encryption key information of the terminal ID, reads the encrypted terminal ID and ECC from the user area 22 of the memory storage device 20 (ST44), and writes in the memory 31.

The host CPU 32 decrypts the encrypted terminal ID and ECC in conformity to the encryption key information Kt in the memory 31 (ST45).

Then, the host CPU 32 carries out data verification of the terminal ID by the decrypted ECC. In the event it verifies the effect that there is no bit error and the like (ST 47), the host CPU 32 writes the terminal ID after data verification in the RAM 50 of the CALSI 36 (ST48).

Hereinafter, initialization processing on and after step ST4 is executed. Furthermore, after initialization processing, the CALSI 36 executes conditional-access processing in conformity to the terminal ID in the RAM 50.

As described above, according to the present embodiment, even under the configuration to store the terminal ID generated from the device ID of the memory storage device 20d in the memory storage device 20d, same as the third embodiment, the identification number of the conditional-access terminal device 30 can be eliminated, and TV viewers can enjoy watching and listening on a plurality of conditional-access terminal devices by replacing the memory storage device 20c.

### Fifth Embodiment

FIG. 11 is a block diagram that indicates a configuration of a memory storage device for use in a conditional-access terminal device according to a fifth embodiment of the invention.

The present embodiment is a modification example of the first embodiment. From the viewpoint of viewing and looking desired broadcasting content at optional time, it has a configuration to record and reproduce the broadcasting content in a memory storage device 20e.

Specifically, the memory storage device 20e comprises a user area 22 and a protected area 21. To the user area 22, descrambled and re-encrypted content information Ec is stored. In the protected area 21, the encryption key information (encryption content key for accumulation and reproduction) Kc for decrypt the encrypted content information Ec in the user area 22 and the copy control information CCI of the content information is encrypted and stored.

As a result, the host CPU 32 of the conditional-access terminal device 30 has the following copy functions (c1) to (c3), reproduction functions (p1) to (p3), and copy control function (cc).

(c1) is a function to read copy control information CCI recorded in the specified channel of broadcasting wave. (c2) is a function to encrypt the broadcasting content on the basis of the encryption key information Kc and update the copy control information, in conformity to the copy control CCI. (c3) is a function to transfer the encrypted broadcasting content Ec, encryption key information Kc, and updated copy control information CCI to the memory storage device 20e to store.

(p1) is a function to read the encrypted broadcasting content Ec, encryption key information Kc, and updated copy control information CCI from the memory storage device 20e. (p2) is a function to decrypt the encrypted broadcasting content Ec on the basis of the encryption key information Kc. (p3) is a function to transfer and regenerate the decrypted broadcasting content C to the CALSI 36. (cc) is a function to copy-control the broadcasting content to be reproduced in conformity to the updated copy control information CCI.

Now, the copy control information CCI has an optional content made usable, such as copy disabled, only one copy enabled, etc. In the event that the broadcasting content has the copy control information that enables copying of one generation only, the content cannot be copied to other memory storage device by the content protection mechanism of the memory storage device 20e. Similarly, in the event that the broadcasting content has copy-disabled copy control information, the CALSI 36 does not copy the content to the memory storage device in conformity to the copy control information.

According to the above-mentioned configuration, the broadcasting content descrambled by the CALSI 36 can be copied to the user area 21 of the memory storage device 20e, and the TV viewers can reproduce the content and watch and listen by the same conditional-access terminal device 30 at any time they please. In addition, because functions related to conditional access can be stored and the program can be recorded in the same memory storage device 20e, and watching and listening, recording, and reproduction of a program are concomitantly used via the slot 41 of the same memory storage device, a conditional-access terminal device with high added value can be provided.

Moreover, because the broadcasting content is copied in conformity to the copy control information, it is possible to prevent content providers from infringing a copyright.

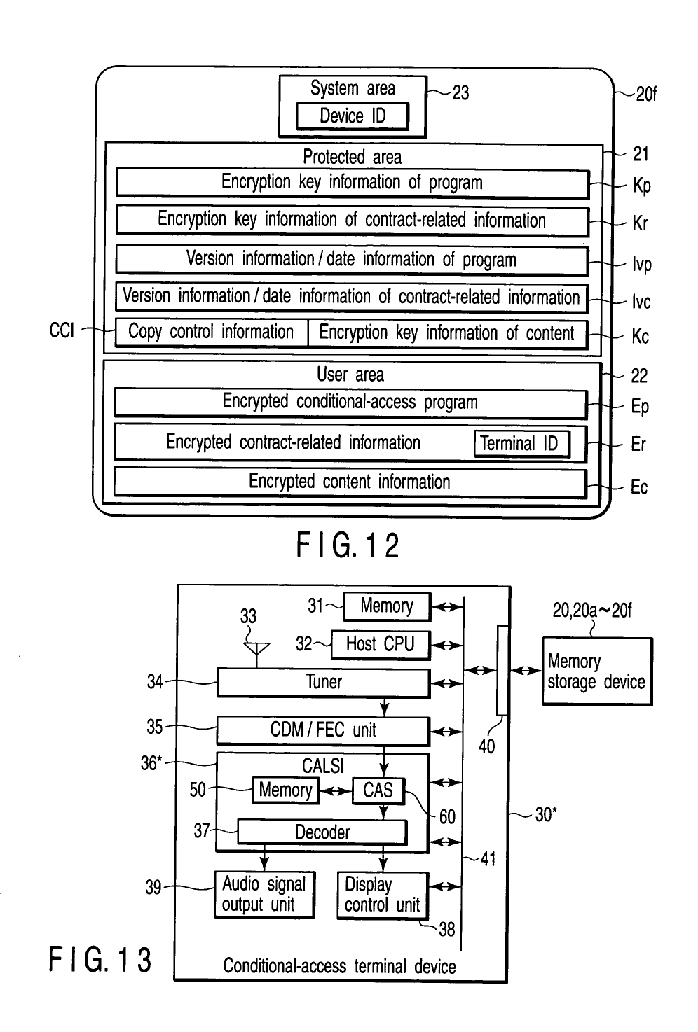

The first to third and fifth embodiments described above may be simultaneously achieved as shown in FIG. 12. Similarly, the first, second, fourth and fifth embodiments may be simultaneously achieved. This is not exclusively applied to these but the first to fifth embodiments may be achieved by combining optional two, three, or four embodiments.

### Sixth Embodiment

FIG. 13 is a block diagram that shows a configuration of a conditional-access terminal device according to a sixth embodiment of the invention.

The present embodiment is a modification example of the first to fifth embodiments and is equipped with a CALSI 36* which combines the above-mentioned CALSI 36 with the decoder 37 to form into one chip.

That is, the CALSI 36* is achieved by a one-chip configuration that includes a decoder to decode the transport stream packet of broadcasting content subject to conditional-access processing.

Because according to the above-mentioned configuration, the CALSI 36* is achieved by a one-chip configuration including the decoder 37 of code-compressed transport stream packet, which is broadcasting content, a small-size conditional-access terminal device 30* suited for mobile reception of digital broadcasting can be achieved.

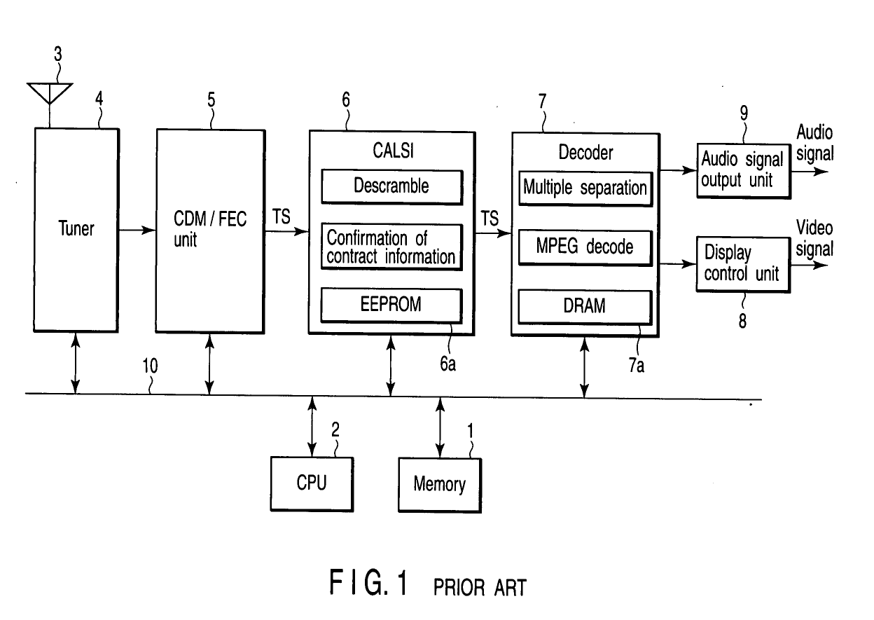

To complement, because the conventional CALSI 6 incorporates the EEPROM 6a that holds the contract of its own terminal shown in FIG. 1 and a decoder LS 17 incorporates a DRAM, both the LSIs 6 and 7 are difficult to be formed into one chip because of problems of the semiconductor manufacturing process.

However, because each of the first through fifth embodiments stores the contract-related information in the memory storage device 20, there is no need to leave the conditional-access program P and contract-related information Ir, etc. in the conditional-access terminal device 30 when the power supply of the conditional-access terminal device 30 is turned off. Therefore, the EEPROM is able to be removed from the CALSI 36.

Accordingly, in the present embodiment, by removing the EEPROM from the CALSI 36 and combining the CALSI 36 with the decoder LSI to be formed into one chip, the semiconductor process of the CALSI 36* can be shortened, and this can contribute to area saving and reduced power consumption, too. In addition, hitherto, the configuration to share descrambling and decoding of broadcasting content between the CALSI and the decoder LSI has resulted in high cost of the conditional-access terminal device. On the other hand, according to the present embodiment, since the CALSI and the decoder LSI are formed into one chip configuration, it is possible to reduce the cost of the conditional-access terminal device.

The present invention as claimed in the application shall not be restricted to the above-mentioned embodiments as they are but can be embodied by modifying component elements without departing from the spirit and the scope of the invention in the embodiment stage. Furthermore, various inventions can be formed by suitably combining a plurality of component elements disclosed in the above-mentioned embodiments. For example, several component elements may be deleted from all the component elements shown in embodiments. Furthermore, component elements covering different embodiments may be suitably combined.

1. A conditional-access terminal device for executing conditional-access processing for a secure memory storage device in which an encrypted conditional-access program and an encryption program key for decrypting the conditional-access program by a conditional-access program obtained from the secure memory storage device, the device comprising:
a conditional-access large scale integrated circuit (LSI) having a memory from and to which the conditional-access program is read and written and a processor which executes conditional-access processing in conformity to the conditional-access program in the memory;
a device configured to read the encrypted conditional-access program and the encryption program key from the secure memory storage device at start up;
a device configured to decrypt the encrypted conditional-access program in conformity to the encryption program key and to obtain the conditional-access program; and
a device configured to write the obtained conditional-access program in memory of the conditional-access LSI.

2. The conditional-access terminal device according to claim 1,
wherein the conditional-access program includes first version control information which includes version or date; and
the secure memory storage device stores second version control information which has the same content as the first version control information, the terminal device further comprising:
a device configured to read the second version control information from the secure memory storage device at start-up;
a device configured to collate the read second version control information with the first version control information contained in the decrypted conditional-access program; and
a device configured to prevent the execution of conditional-access processing when both pieces of information do not coincide as a result of the collation.

3. A conditional-access terminal device for executing conditional-access processing for a secure memory storage device in which encrypted “contract-related information” and an encryption contract information key for decrypting the “contract-related information” by “contract-related information” obtained from the secure memory storage device, the terminal device further comprising:
a conditional-access large scale integrated circuit (LSI) having a memory from and to which the “contract-related information” is read and written and a processor which executes conditional-access processing in conformity to the “contract-related information” in the memory;
a device configured to read the encrypted “contract-related information” and the encryption contract information key from the secure memory storage device at start-up;
a device configured to decrypt the encrypted “contract-related information” in conformity to the encryption contract information key and to obtain the “contract-related information”;
a device configured to write the obtained “contract-related information” in memory of the conditional-access LSI;
a device configured to send the new “contract-related information” from the relevant conditional-access LSI when the new “contract-related information” is received while conditional-access processing by the conditional-access LSI is being carried out; and
a device configured to encrypt the sent-out “contract-related information” by the encryption contract information key and transfer the obtained encrypted “contract-related information” to the secure memory storage device to update and store.

4. The conditional-access terminal device according to claim 3,
wherein the contract-related information includes first version control information which includes version or date; and
the secure memory storage device stores second version control information which has the same content as the first version control information, the terminal device further comprising:
a device configured to read the second version control information from the secure memory storage device at start-up;
a device configured to collate the read second version control information with the first version control information contained in the decrypted “contract-related information”; and
a device configured to prevent the execution of conditional-access processing when both pieces of information do not coincide as a result of the collation.

5. The conditional-access terminal device according to claim 4,
wherein the secure memory storage device stores its own medium identification information, and
the “contract-related information” includes terminal identification information calculated from the medium identification information, and the conditional-access LSI comprises:
a device configured to execute the conditional-access processing in conformity to the terminal identification information contained in the “contract-related information” in the memory.

6. The conditional-access terminal device according to claim 1,
wherein the secure memory storage device stores its own medium identification information, terminal identification information which is the encrypted terminal identification information calculated from this medium identification information, and an encryption identification information key to decrypt this encrypted terminal identification information, the terminal device further comprising:
a device configured to read the encryption identification information key and the encrypted medium identification information from the secure memory storage device;
a device configured to decrypt the encrypted medium identification information in conformity to the encryption contract information key and to obtain the terminal identification information;
a device configured to write the obtained terminal identification information in memory of the conditional-access LSI; and
a device configured to execute the conditional-access processing in conformity to the terminal identification information in the memory.

7. The conditional-access terminal device according to claim 1, further comprising:
a device configured to read the copy control information recorded in the specified channel of broadcasting waves with respect to the broadcasting waves containing scrambled broadcasting content and copy control information;
a device configured to encrypt the broadcasting content in conformity to the accumulation-reproduction encryption content key, which is scrambled by the conditional-access processing in accordance with this copy control information;
a device configured to update the copy control information;
a device configured to transfer the encrypted broadcasting content, the encryption content key, and the updated copy control information to the secure memory storage device;
a device configured to read the encrypted broadcasting content, the accumulation-reproduction encryption content key, and updated copy control information from the secure memory storage device;
a device configured to decrypt the encrypted broadcasting content in conformity to the accumulation-reproduction encryption content key;
a device configured to reproduce the decrypted broadcasting content; and
a device configured to copy-control the broadcasting content to be reproduced in conformity to the updated copy control information.

8. The conditional-access terminal device according to claim 1,
wherein the conditional-access LSI includes a decoder that decodes the transport stream packet of the broadcasting content subject to the conditional-access processing.

9. A conditional-access method for use in a conditional-access terminal device for executing conditional-access processing by a conditional access program obtained from a secure memory storage device with the secure memory storage device in which an encrypted conditional-access program and an encryption program key for decrypting the conditional-access program,
wherein the conditional-access terminal device comprises: a conditional-access large scale integrated circuit (LSI) having memory from and to which the conditional-access program is read and written and a processor to execute conditional-access processing in compliance with a conditional-access program in the memory, the method comprising:
reading the encrypted conditional-access program and the encryption program key from the secure memory storage device at start-up, by the conditional-access terminal device;
decrypting the encrypted conditional-access program in compliance with the read encryption program key, by the conditional-access terminal device; and
writing the decoded conditional-access program in memory of the conditional-access LSI, by the conditional-access terminal device.

10. A conditional-access method for use in a conditional-access terminal device for executing conditional-access processing by “contract-related information” obtained from a secure memory storage device having stored therein encrypted “contract-related information” and an encryption contract information key for decrypting the “contract-related information”,
wherein the conditional-access terminal device comprises: a conditional-access large scale integrated circuit (LSI) having a memory from and to which the “contract-related information” is read and written and a processor to execute conditional-access processing in compliance with a “contract-related information” in the memory, the method comprising:
reading the encrypted “contract-related information” and the encryption contract information key from the secure memory storage device at start-up, by the conditional-access terminal device;
decrypting the encrypted “contract-related information” in compliance with the read encryption contract information key, by the conditional-access terminal device;
writing the decoded “contract-related information” in the memory of the conditional-access LSI, by the conditional-access terminal device;
sending the new “contract-related information” to the relevant conditional-access LSI when the conditional-access terminal device receives the new “contract-related information” while conditional-access processing by the conditional-access LSI is being implemented, by the conditional-access terminal device; and
encrypting the sent-out “contract-related information” by the encryption contract information key and transferring the obtained encrypted “contract-related information” to the secure memory storage device for updating and storing, by the conditional-access terminal device.
